(19) United States
(12) Patent Application Publication
(10) Pub. No.: US 2024/0286589 A1
(43) Pub. Date: Aug. 29, 2024

(54) BRAKE SYSTEM AND BRAKE PEDAL DEVICE

(71) Applicant: DENSO CORPORATION, Kariya-city (JP)

(72) Inventors: Yoshinori INUZUKA, Kariya-city (JP); Kazuhiro YOSHIDA, Kariya-city (JP)

(21) Appl. No.: 18/657,483

(22) Filed: May 7, 2024

Related U.S. Application Data
(63) Continuation of application No. PCT/JP2022/039932, filed on Oct. 26, 2022.

(30) Foreign Application Priority Data
Nov. 10, 2021 (JP) 2021-183590

(51) Int. Cl. B60T 7/04; B60T 13/66

(52) U.S. Cl. CPC B60T 7/042; B60T 13/662; B60T 2220/04

(57) ABSTRACT

A brake system includes four sensors and at least two electronic control units. The four sensors are a first sensor, a second sensor, a third sensor, and a fourth sensor. The first sensor transmits a sensor output signal generated therein to a predetermined electronic control unit among the at least two electronic control units. The second sensor transmits a sensor output signal generated therein to other electronic control unit that is different from the predetermined electronic control unit among the at least two electronic control units. The third sensor transmits a sensor output signal generated therein to at least one of the predetermined electronic control unit and the other electronic control unit. The fourth sensor transmits a sensor output signal generated in its own sensor to both of the predetermined electronic control unit and the other electronic control unit.

### CROSS REFERENCE TO RELATED APPLICATIONS

The present application is a continuation application of International Patent Application No. PCT/JP2022/039932 filed on Oct. 26, 2022, which designated the U.S. and claims the benefit of priority from Japanese Patent Application No. 2021-183590 filed on Nov. 10, 2021. The entire disclosures of all of the above applications are incorporated herein by reference.

### TECHNICAL FIELD

The present disclosure relates to a brake system and a brake pedal device mounted on a vehicle.

### BACKGROUND

Conventionally, a brake-by-wire system is known in which an electronic control unit detects an amount of operation of a brake pedal based on an output signal of a sensor that outputs a signal corresponding to an amount of operation of the brake pedal by a driver, and controls a brake circuit to brake a vehicle.

### SUMMARY

According to one aspect of the present disclosure, a brake system configured to drive and control a brake circuit that brakes a vehicle, includes four sensors and at least two electronic control units. The four sensors are configured to generate and output sensor output signals according to an amount of operation of a brake pedal operated by a driver. The at least two electronic control units are configured to control a driving of the brake circuit based on a sensor output signal output from the sensor.

For example, the four sensors are a first sensor, a second sensor, a third sensor, and a fourth sensor. In this case, the first sensor is configured to transmit a sensor output signal generated therein to a predetermined electronic control unit among the at least two electronic control units. The second sensor is configured to transmit a sensor output signal generated therein to an other electronic control unit that is different from the predetermined electronic control unit among the at least two electronic control units. The third sensor is configured to transmit a sensor output signal generated therein to at least one of the predetermined electronic control unit or the other electronic control unit. The fourth sensor is configured to transmit a sensor output signal generated therein to both of the predetermined electronic control unit and the other electronic control unit.

According to another aspect of the present disclosure, a brake pedal device may be used in a brake system that includes at least two electronic control units for driving and controlling a brake circuit that brakes a vehicle. The brake pedal device includes a brake pedal to be operated by a driver and four sensors configured to generate and output sensor output signals according to an amount of operation of the brake pedal. For example, the four sensors may be similar to those of the above one aspect.

### BRIEF DESCRIPTION OF THE DRAWINGS

The above and other objects, features and advantages of the present disclosure will become more apparent from the following detailed description made with reference to the accompanying drawings. In the drawings:

FIG. 1 is a block diagram of a schematic configuration of a brake system according to a first embodiment;

FIG. 2 is a side view of a brake pedal device of the brake system according to the first embodiment;

FIG. 3 is a block diagram of a schematic configuration of a brake system according to a second embodiment;

FIG. 4 is a block diagram of a schematic configuration of a brake system according to a third embodiment; and

FIG. 5 is a block diagram of a schematic configuration of a brake system according to a fourth embodiment.

### DESCRIPTION OF EMBODIMENTS

In the following description, an electronic control unit is referred to as an “ECU,” an amount of operation of a brake pedal is referred to as a “pedal operation amount,” and a brake-by-wire system is referred to as a “brake system”, for example. The ECU is an abbreviation for electronic control unit. The ECU that drives and controls the brake circuit is sometimes called as a BCU. The BCU is an abbreviation for Brake Control Unit.

A brake system of a comparative example may include six sensors that detect the amount of operation of a brake pedal, two ECUs, and two power supply devices. In this example, the six sensors include four position sensors and two force sensors. In this braking system, it is configured that electric power is supplied from one of the two power supply devices to three sensors (specifically, two position sensors and one force sensor), and electric power is supplied from the other power supply device is supplied to three other sensors. Additionally, in this brake system, output signals from three sensors (specifically, the same two position sensors and one force sensor as the above) are sent to one of the two ECUs, and the output signals from three other sensors are transmitted to the other ECU. In such manner, even when one power supply device fails, the output signals of the other three sensors that are supplied with electric power from the other power supply device will be sent to the other ECU, thereby the control of the brake circuit can be performed by the other ECU even when one power supply device fails in the brake system. In such manner, this brake system is designed to have redundancy against a failure of the power supply device and a failure of the ECU.

Although the brake system is provided with redundancy against a failure of the power supply device and a failure of the ECU in the brake system, the brake system has a large number of sensors, i.e., six sensors. Therefore, there may be a problem in that the size of the brake pedal device including the large number of sensors increases, and the manufacturing cost thereof also increases.

It is an object of the present disclosure to provide a necessary and sufficient system configuration that can ensure redundancy for brake pedal sensing in a brake-by-wire system by optimizing a number of sensors and optimizing a routing method of sensor information.

According to one aspect of the present disclosure, a brake system, configured to drive and control a brake circuit that brakes a vehicle, includes four sensors and at least two electronic control units. The four sensors are configured to generate and output sensor output signals according to an amount of operation of a brake pedal operated by a driver. The at least two electronic control units are configured to control a driving of the brake circuit based on a sensor output signal output from the sensor. Here, the four sensors are a first sensor, a second sensor, a third sensor, and a fourth sensor, respectively. In this case, the first sensor is configured to transmit a sensor output signal generated therein to a predetermined electronic control unit among the at least two electronic control units. The second sensor is configured to transmit a sensor output signal generated therein to an other electronic control unit that is different from the predetermined electronic control unit among the at least two electronic control units. The third sensor is configured to transmit a sensor output signal generated therein to at least one of the predetermined electronic control unit or the other electronic control unit. The fourth sensor is configured to transmit a sensor output signal generated therein to both of the predetermined electronic control unit and the other electronic control unit.

According to the above one aspect, in the brake system, the sensor output signals of the three sensors are input to at least one of the predetermined electronic control unit or the other electronic control unit. Therefore, when one of the three sensors is in failure, the electronic control unit to which the sensor output signals of the three sensors are input can identify the failed sensor by majority decision. At the same time, the electronic control unit can accurately detect the pedal operation amount based on normal sensor output signals excluding the signal from the failed sensor.

Further, in the brake system, sensor output signals from two or more sensors are input to both of the predetermined electronic control unit and the other electronic control unit. Therefore, even when one of the predetermined electronic control unit or the other electronic control unit fails, the other electronic control unit can drive and control the brake circuit. Thus, such brake system can ensure redundancy against a failure of the electronic control unit.

In such manner, in the brake system of the present disclosure, functions such as identifying a failed sensor by majority decision and ensuring redundancy in case of a failure of the electronic control unit are made by a routing method using four sensors. Therefore, in the brake system, by optimizing the number of sensors, manufacturing costs can be reduced and the size of the brake pedal device can be reduced at the same time.

Further, the predetermined electronic control unit and the other electronic control unit do not require communication therebetween, i.e., between the predetermined electronic control unit and the other electronic control unit, for the sensor output signals of the four sensors. Therefore, the brake system can reduce control processing load of the electronic control unit.

According to another aspect of the present disclosure, a brake pedal device is used in a brake system that includes at least two electronic control units for driving and controlling a brake circuit that brakes a vehicle. The brake pedal device includes a brake pedal to be operated by a driver and four sensors configured to generate and output sensor output signals according to an amount of operation of the brake pedal. Here, the four sensors are arbitrarily referred to as a first sensor, a second sensor, a third sensor, and a fourth sensor. The first sensor is configured to transmit a sensor output signal generated therein to a predetermined electronic control unit among the at least two electronic control units. The second sensor is configured to transmit a sensor output signal generated therein to an other electronic control unit that is different from the predetermined electronic control unit among the at least two electronic control units. The third sensor is configured to transmit a sensor output signal generated therein to at least one of the predetermined electronic control unit or the other electronic control unit. The fourth sensor is configured to transmit a sensor output signal generated therein to both of the predetermined electronic control unit and the other electronic control unit.

According to the above, the brake pedal device according to another aspect can also have the same effect as the brake system according to the above one aspect.

Embodiments of the present disclosure will now be described with reference to the drawings. In the following embodiments, the same or equivalent parts are denoted by the same reference numerals as each other, and redundant explanations to the same reference numerals will be omitted.

### First Embodiment

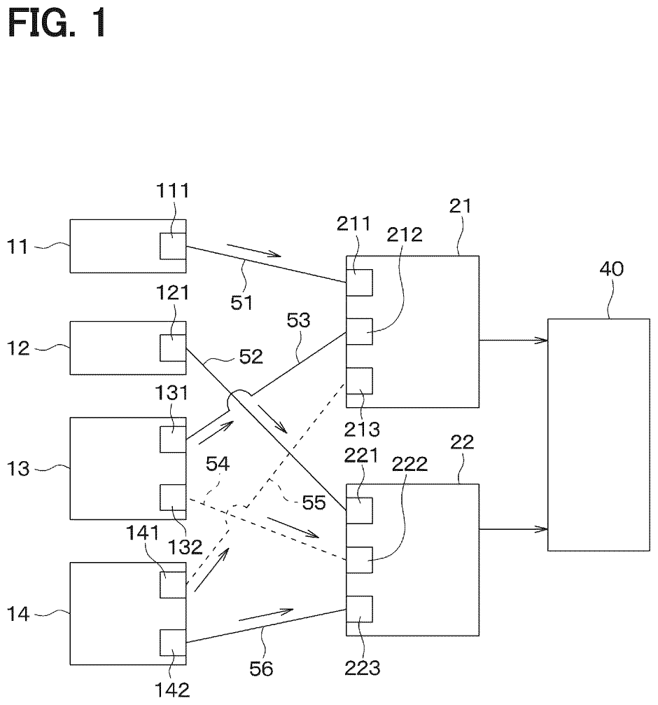

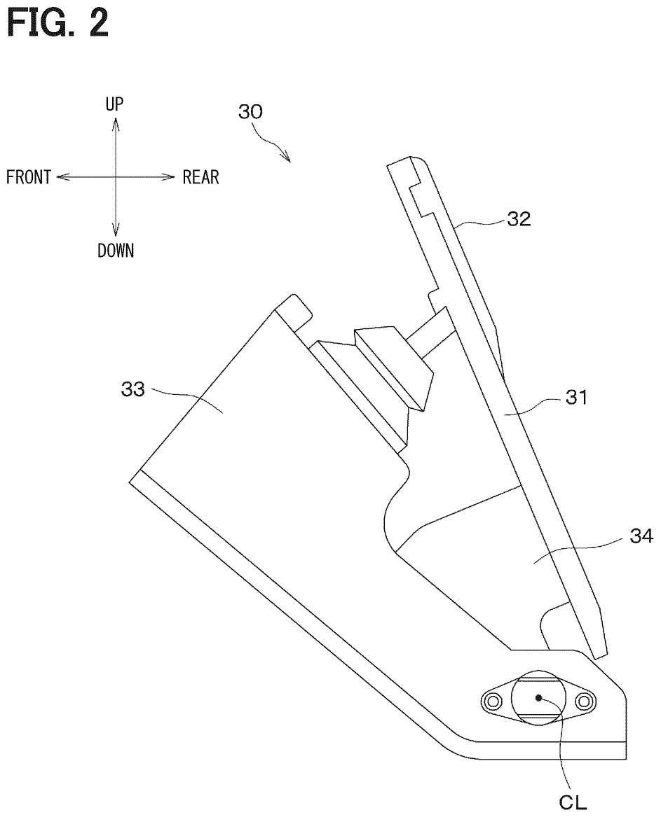

A brake system according to the first embodiment will be described with reference to FIGS. 1 and 2. The brake system of the first embodiment is a brake-by-wire system in which electronic control units (hereinafter referred to as “ECU”) 21 and 22 drive and control a brake circuit 40 based on an amount of operation of a brake pedal 31 to brake a vehicle. Note that the ECU that drives and controls the brake circuit 40 may sometimes be called as a BCU.

As shown in FIG. 1, the brake system of the first embodiment includes four sensors 11 to 14 and two ECUs 21 and 22. The four sensors 11 to 14 are provided, for example, in a brake pedal device 30 as shown in FIG. 2.

In FIG. 2, an organ-type brake pedal device 30 is shown as an example of the brake pedal device 30. In the organ-type brake pedal device 30, a portion 32 of the brake pedal 31 that is depressed by a driver is disposed at a position above a swing axis CL in the vertical direction when mounted on a vehicle. Note that the coordinates shown in FIG. 2 indicate the up-down direction and the front-back direction when the brake pedal device 30 is mounted on the vehicle.

The brake pedal device 30 includes a housing 33, the brake pedal 31, and the like. The housing 33 is fixed to a floor or dash panel of the vehicle with bolts (not shown) or the like. The brake pedal 31 is formed in a plate shape, and is arranged diagonally with respect to the floor of the vehicle. Specifically, the brake pedal 31 is arranged diagonally so that its upper end is positioned on a front side of the vehicle and its lower end is positioned on a rear side of the vehicle. A thick portion is provided in an upper portion of the brake pedal 31 as a portion 32 that is depressed by the driver.

A connecting member 34 fixed to the brake pedal 31 is fixed to a rotating shaft (not shown) provided in the housing 33. Therefore, the brake pedal 31 is provided to be swingable around the predetermined swing axis CL provided in the housing 33. Note that in the present specification, swing refers to rotational movement in forward and reverse directions about the predetermined swing axis CL in a predetermined angular range.

Although not shown in FIG. 2, in the housing 33, a reaction force generating mechanism that generates a reaction force against a pedaling force applied by the driver to the brake pedal 31, four sensors 11 to 14, and the like are provided. In FIG. 2, illustration of the reaction force generating mechanism and the four sensors 11 to 14 is omitted.

The four sensors 11 to 14 shown in FIG. 1 are provided in the brake pedal device 30, and generate and output sensor output signals corresponding to the amount of operation of the brake pedal 31 depressed by the driver.

The four sensors 11 to 14 may all detect the same physical quantity, or may each detect different physical quantities. In the first embodiment, from the viewpoint of redundancy, the four sensors 11 to 14 are implemented as sensors detecting two types of physical quantities (for example, a pedal swing angle and a pedal stroke amount) as pedal operation amounts using respectively different detection principles. Specifically, as a sensor for detecting the pedal swing angle, for example, a magnetic sensor using a Hall element or a magnetic resistance element is employed. For example, an inductive sensor is employed as the sensor that detects the pedal stroke amount. Note that the types of the four sensors 11 to 14 are not limited to those described above, and various types such as pressure sensors, photoelectric sensors, etc. can be employed.

Sensor output signals generated by the four sensors 11 to 14 are transmitted to the two ECUs 21 and 22. Note that the transmission method regarding the above will be described later.

The two ECUs 21 and 22 are composed of a processor that performs control processing and arithmetic processing, a microcomputer including a storage unit such as ROM and RAM that stores programs, data, etc., and its peripheral circuits. The storage unit includes non-transitory, tangible storage media. The ECUs 21 and 22 perform various control processes and arithmetic processes based on programs stored in the storage unit, and control the operation of each device connected to an output port. Specifically, the ECUs 21 and 22 detect accurate pedal operation amounts based on sensor output signals generated by the four sensors 11 to 14, and control the drive of the brake circuit 40.

Various mechanisms can be employed as the brake circuit 40. For example, as the brake circuit 40, an electric brake may be employed in which an electric motor is driven by an instruction from the ECUs 21 and 22, and brakes each wheel by pressing a brake pad against a disc brake rotor. Alternatively, for example, the brake circuit 40 may be configured to increase a hydraulic pressure of brake fluid by operating a master cylinder or a hydraulic pump, drive a wheel cylinder disposed on each wheel, and operate the brake pad. Further, the brake circuit 40 is also capable of performing normal control, ABS control, VSC control, etc. according to control signals from the ECUs 21 and 22. ABS stands for Anti-Lock Braking System, and VSC stands for Vehicle Stability Control.

Next, a transmission method for transmitting sensor output signals from the four sensors 11 to 14 to the two ECUs 21 and 22 will be described.

In the following explanation, for convenience of explanation, the four sensors 11 to 14 will be referred to as a first sensor 11, a second sensor 12, a third sensor 13, and a fourth sensor 14 from the top to the bottom of the paper in FIG. 1. Further, in the following description, for convenience of explanation, of the two ECUs 21 and 22, the one on an upper side of the paper in FIG. 1 is referred to as the first ECU 21, and the one on a lower side of the paper in FIG. 1 is referred to as the second ECU 22. The first ECU 21 corresponds to a “predetermined electronic control unit,” and the second ECU 22 corresponds to an “other electronic control unit.” Further, in the following description, for convenience of explanation, the wirings shown in FIG. 1 will be referred to as first to sixth wirings 51 to 56. Note that the names of the first to fourth sensors 11 to 14 do not limit a mounting position on the brake pedal device 30 or the type of the sensors. The names of the first ECU 21 and the second ECU 22 do not limit their mounting positions. These matters are the same in the description of the second to fourth embodiments described later.

The first sensor 11 transmits a sensor output signal generated in its own sensor from a transmitter 111 of the first sensor 11 to a first receiver 211 of the first ECU 21 via the first wiring 51.

The second sensor 12 transmits a sensor output signal generated in its own sensor from a transmitter 121 of the second sensor 12 to a first receiver 221 of the second ECU 22 via the second wiring 52.

The third sensor 13 processes one sensor output signal generated in its own sensor to make two output signals by duplicating the one sensor output signal with an integrated circuit in the sensor, thereby generating and distribute two sensor output signals. The duplicated, two sensor signals are the same signals. Then, the third sensor 13 transmits one of the two sensor output signals from a first transmitter 131 of the third sensor 13 to a second receiver 212 of the first ECU 21 via the third wiring 53. Further, the third sensor 13 transmits the other sensor output signal of the two sensor output signals from a second transmitter 132 of the third sensor 13 to a second receiver 222 of the second ECU 22 via the fourth wiring 54. That is, the third sensor 13 duplicates one sensor output signal generated in its own sensor using an integrated circuit in the sensor to generate two sensor output signals, and transmits the two sensor output signals to the first ECU 21 and to the second ECU 22, respectively.

The fourth sensor 14 also processes one sensor output signal generated in its own sensor to make two output signals by duplicating it with an integrated circuit in the sensor, thereby generating and distribute two sensor output signals. The duplicated, two sensor signals are the same signals. Then, the fourth sensor 14 transmits one of the two sensor output signals from a first transmitter 141 of the fourth sensor 14 to a third receiver 213 of the first ECU 21 via the fifth wiring 55. Further, the fourth sensor 14 transmits the other sensor output signal of the two sensor output signals from a second transmitter 142 of the fourth sensor 14 to a third receiver 223 of the second ECU 22 via the sixth wiring 56. Therefore, the fourth sensor 14 duplicates one sensor output signal generated in its own sensor using the integrated circuit in the sensor to generate two sensor output signals, and transmits the two sensor output signals to the first ECU 21 and the second sensor output signal, respectively.

As a communication method between each of the sensors 11 to 14 and each of the ECUs 21, 22, analog communication, digital communication, optical communication, and the like are adoptable. Examples of digital communication include SPI, I2C, UART, SENT and the like. SPI is abbreviation for Serial Peripheral Interface. I2C is an abbreviation for Inter-Integrated Circuit. UART is an abbreviation for Universal Asynchronous Receiver/Transmitter. SENT is an abbreviation for Single Edge Nibble Transmission.

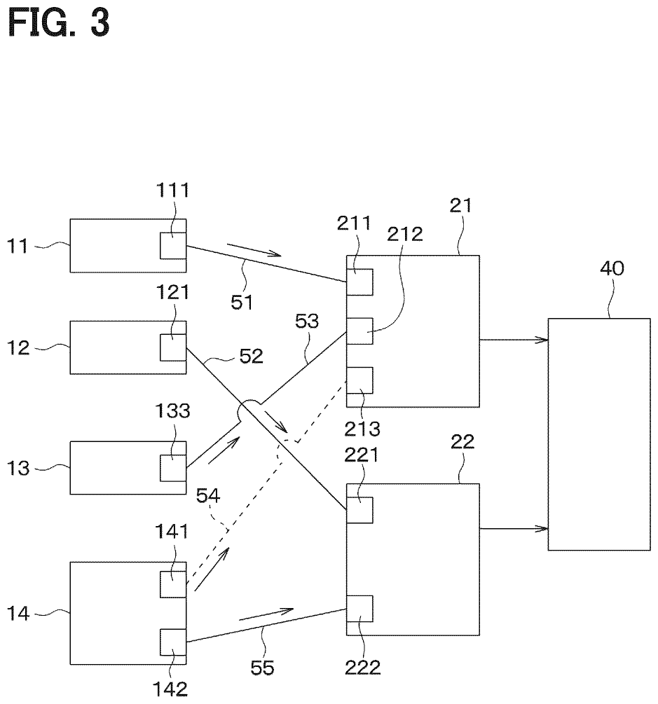

Note that when SENT is adopted as the communication method, a transmitter unit is a driver and a receiver unit is a receiver. In FIG. 1, when SENT is employed, wiring including a supply voltage line, a signal line, and a ground line is shown by a solid line. On the other hand, wiring that has a signal line and a ground line but does not have a supply voltage line is shown by a broken line. Note that such configuration also applies to FIGS. 3 to 5, which will be referred to in second to fourth embodiments described later.

In FIG. 1, the first wiring 51, the second wiring 52, the third wiring 53, and the sixth wiring 56 are wirings having the supply voltage line, the signal line, and the ground line. On the other hand, the fourth wiring 54 and the fifth wiring 55 are wirings that have the signal line and the ground line, but do not have the supply voltage line. Therefore, the third sensor 13 operates by receiving supply of electric power from the first ECU 21 via the third wiring 53. Therefore, the third sensor 13 can continue to operate even when the second ECU 22 fails. On the other hand, the fourth sensor 14 operates by receiving supply of electric power from the second ECU 22 via the sixth wiring 56. Therefore, the fourth sensor 14 can continue to operate even when the first ECU 21 fails.

On the other hand, when analog communication is adopted as the communication method, the transmitter unit and the receiver unit are terminals, wiring, or connectors.

As explained above, in the brake system of the first embodiment, the sensor output signals of the first sensor 11, the third sensor 13, and the fourth sensor 14 are input to the first ECU 21. On the other hand, the sensor output signals from the second sensor 12, the third sensor 13, and the fourth sensor 14 are input to the second ECU 22. Therefore, when one sensor out of three sensors from which a sensor output signal is input to the first and second ECUS 21 and 22 has failed, the first ECU 21 and the second ECU 22 can identify the failed sensor by majority decision. At the same time, the first ECU 21 and the second ECU 22 can accurately detect the pedal operation amount based on normal sensor output signals excluding the failed sensor.

For example, a specific example of a method for identifying a failed sensor by majority decision and detecting an accurate pedal operation amount when three sensor output signals are input to the ECUs 21 and 22 is described in Japanese Patent Application No. 2021-142749, filed by the same applicant as the present disclosure, which is incorporated herein by reference.

Further, in the first embodiment, three sensor output signals are input to both of the first ECU 21 and the second ECU 22. Therefore, even when either of the first ECU 21 or the second ECU 22 fails, the other ECU can drive and control the brake circuit 40. Therefore, the brake system of the present embodiment can ensure redundancy against failures of the ECUs 21 and 22.

As described above, the brake system of the first embodiment is capable of constructing functionality as a routing method using the four sensors 11 to 14, such as identifying a failed sensor by majority decision and ensuring redundancy against a failure of the ECUs 21 and 22. Therefore, in this brake system, by optimizing the number of sensors, manufacturing costs can be reduced and the size of the brake pedal device 30 can be reduced.

Further, in the brake system of the first embodiment, the first ECU 21 and the second ECU 22 do not require communication between the first ECU 21 and the second ECU 22 regarding the sensor output signals of the four sensors 11 to 14. Therefore, this brake system can reduce the control processing load of the ECUs 21 and 22.

Further, in the first embodiment, from the viewpoint of redundancy, at least one of the four sensors 11 to 14 is a magnetic sensor, and the other sensors are inductive sensors. According to the above, the brake system of the first embodiment employs a plurality of non-contact sensors with different detection principles, such as a magnetic sensor and an inductive sensor, for the four sensors 11 to 14. Therefore, even when the output signal of one sensor becomes abnormal due to the proximity of magnetic foreign matter or conductive foreign matter, which each of the sensors is sensitive to, the output signals of the other sensors can remain normal. Therefore, this brake system can ensure redundancy of the output signals of the sensors by preventing simultaneous sensor failures.

### Second Embodiment

The following describes the second embodiment of the present disclosure. The second embodiment differs from the first embodiment in a method of transmitting sensor output signals from the four sensors 11 to 14 to the two ECUs 21 and 22, and the other aspects are the same as in the first embodiment, thereby only the configurations that are different from the first embodiment will be explained.

In the second embodiment, the method of transmitting sensor output signals from four sensors 11 to 14 to two ECUs 21 and 22 will be described with reference to FIG. 3.

The first sensor 11 transmits a sensor output signal generated in its own sensor from a transmitter 111 of the first sensor 11 to a first receiver 211 of the first ECU 21 via a first wiring 51.

The second sensor 12 transmits a sensor output signal generated in its own sensor from a transmitter 121 of the second sensor 12 to a first receiver 221 of the second ECU 22 via a second wiring 52.

The third sensor 13 transmits a sensor output signal generated in its own sensor from a transmitter 133 of the third sensor 13 to a second receiver 212 of the first ECU 21 via a third wiring 53.

The fourth sensor 14 divides one sensor output signal generated in its own sensor into two by duplicating it with an integrated circuit in the sensor, thereby generating two sensor output signals. The duplicated, two sensor signals are the same signals. Then, the fourth sensor 14 transmits one of the two sensor output signals from a first transmitter 141 of the fourth sensor 14 to a third receiver 213 of the first ECU 21 via a fourth wiring 54. Further, the fourth sensor 14 transmits the other of the two sensor output signals from a second transmitter 142 of the fourth sensor 14 to a second receiver 222 of the second ECU 22 via a fifth wiring 55. Therefore, the fourth sensor 14 duplicates one sensor output signal generated in its own sensor using the integrated circuit in the sensor to generate two sensor output signals, and transmits the two sensor output signals to the first ECU 21 and the second sensor output signal, respectively.

As a communication method between each of the sensors 11 to 14 and each of the ECUs 21, 22, analog communication, digital communication, optical communication, and the like are adoptable. Examples of digital communications include SPI, I2C, UART, SENT, and the like.

Note that when SENT is adopted as the communication method, a transmitter unit is a driver and a receiver unit is a receiver. In the second embodiment, the first wiring 51, the second wiring 52, the third wiring 53, and the fifth wiring 55 are wirings having the supply voltage line, the signal line, and the ground line. On the other hand, the fourth wiring 54 is a wiring that has the signal line and the ground line, but does not have the supply voltage line. Therefore, the fourth sensor 14 operates by receiving supply of electric power from the second ECU 22. Therefore, the fourth sensor 14 can continue to operate even when the first ECU 21 fails.

On the other hand, when analog communication is adopted as the communication method, the transmitter unit and the receiver unit are terminals, wiring, or connectors.

As explained above, in the brake system of the second embodiment, sensor output signals from the first sensor 11, the third sensor 13, and the fourth sensor 14 are input to the first ECU 21. On the other hand, sensor output signals from the second sensor 12 and the fourth sensor 14 are input to the second ECU 22. Therefore, when one sensor out of three sensors from which a sensor output signal is input to the first ECU 21 has failed, the first ECU 21 can still identify the failed sensor by majority decision. At the same time, the first ECU 21 can accurately detect the pedal operation amount based on normal sensor output signals excluding the failed sensor.

Further, in the second embodiment, two or more sensor output signals are input to both of the first ECU 21 and the second ECU 22. Therefore, even when either of the first ECU 21 or the second ECU 22 fails, the other ECU can drive and control the brake circuit 40. Therefore, the brake system of the present embodiment can ensure redundancy against failures of the ECUs 21 and 22.

In such manner, in the brake system of the second embodiment as well, functions such as identifying a failed sensor by majority decision and ensuring redundancy in case of a failure of the ECUs 21 or 22 are constructable by a routing method using the four sensors 11 to 14. Therefore, in this brake system, by optimizing the number of sensors, manufacturing costs can be reduced and the size of the brake pedal device can be reduced at the same time.

Further, in the brake system of the second embodiment, the first ECU 21 and the second ECU 22 do not require communication between the first ECU 21 and the second ECU 22 regarding the sensor output signals of the four sensors 11 to 14. Therefore, this brake system can reduce the control processing load of the ECUs 21 and 22.

### Third Embodiment

The following describes the third embodiment of the present disclosure. The third embodiment also differs from the first embodiment in a method of transmitting sensor output signals from the four sensors 11 to 14 to the two ECUs 21 and 22, and other aspects are the same as the first embodiment, thereby only the parts different from the first embodiment and the like will be described.

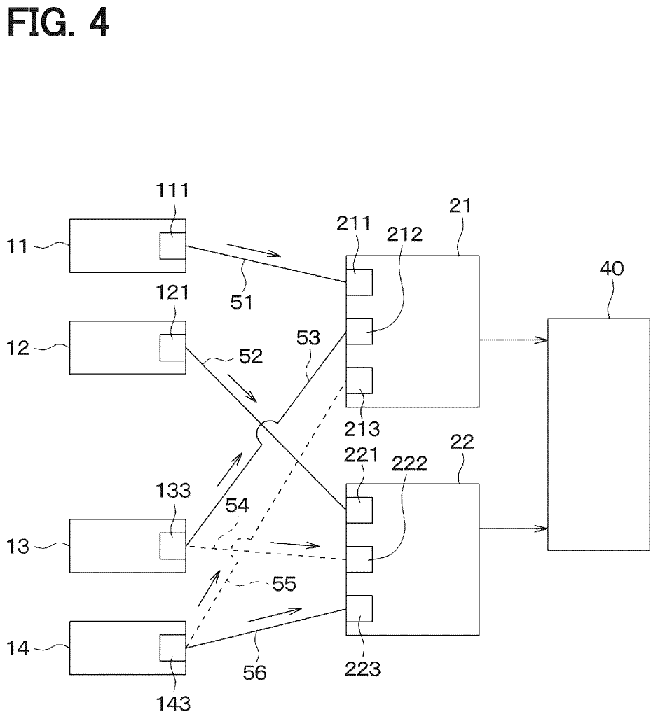

In the third embodiment, a method of transmitting sensor output signals from the four sensors 11 to 14 to the two ECUs 21 and 22 will be explained with reference to FIG. 4.

A first sensor 11 transmits a sensor output signal generated in its own sensor from a transmitter 111 of the first sensor 11 to a first receiver 211 of the first ECU 21 via a first wiring 51.

A second sensor 12 transmits a sensor output signal generated in its own sensor from a transmitter 121 of the second sensor 12 to a first receiver 221 of the second ECU 22 via a second wiring 52.

A third sensor 13 processes one sensor output signal generated in its own sensor to make and distribute two output signals using a wiring configuration provided in a transmitter 133 or the like. In the present disclosure, the wiring configuration refers to physical means such as terminals, connectors, harnesses, and the like. The two sensor signals duplicated by the wiring configuration are the same signal. Then, the third sensor 13 transmits one of the two sensor output signals from the transmitter 133 of the third sensor 13 to a second receiver 212 of the first ECU 21 via a third wiring 53. Further, the third sensor 13 transmits the other of the two sensor output signals from the transmitter 133 of the third sensor 13 to a second receiver 222 of the second ECU 22 via a fourth wiring 54. Therefore, the third sensor 13 processes one sensor output signal generated in its own sensor to make two sensor output signals by the wiring configuration, and transmits the two sensor output signals to the first ECU 21 and the second ECU 22, respectively.

The fourth sensor 14 also processes one sensor output signal generated in its own sensor to make and distribute two output signals through a wiring configuration provided in a transmitter 143 or the like. The two sensor signals duplicated by the wiring configuration are the same signal. Then, the fourth sensor 14 transmits one of the two sensor output signals from the transmitter 143 of the fourth sensor 14 to a third receiver 213 of the first ECU 21 via a fifth wiring 55. Further, the fourth sensor 14 transmits the other of the two sensor output signals from the transmitter 143 of the fourth sensor 14 to a third receiver 223 of the second ECU 22 via a sixth wiring 56. Therefore, the fourth sensor 14 also processes one sensor output signal generated in its own sensor to make two sensor output signals by the wiring configuration, and transmits the two sensor output signals to the first ECU 21 and the second ECU 22, respectively.

As a communication method between each of the sensors 11 to 14 and each of the ECUs 21, 22, analog communication, digital communication, optical communication, and the like are adoptable. Examples of digital communications include SPI, I2C, UART, SENT, and the like.

Note that when SENT is adopted as the communication method, a transmitter unit is a driver and a receiver unit is a receiver. In the third embodiment, the first wiring 51, the second wiring 52, the third wiring 53, and the sixth wiring 56 are wirings having the supply voltage line, the signal line, and the ground line. On the other hand, the fourth wiring 54 and the fifth wiring 55 are wirings that have the signal line and the ground line, but do not have the supply voltage line. Therefore, the third sensor 13 operates by receiving supply of electric power from the first ECU 21. Therefore, the third sensor 13 can continue to operate even when the second ECU 22 fails. On the other hand, the fourth sensor 14 operates by receiving supply of electric power from the second ECU 22. Therefore, the fourth sensor 14 can continue to operate even when the first ECU 21 fails.

On the other hand, when analog communication is adopted as the communication method, the transmitter unit and the receiver unit are terminals, wiring, or connectors.

As explained above, the brake system of the third embodiment can also provide the same effects as the first embodiment. Further, in the third embodiment, the third sensor 13 and the fourth sensor 14 can duplicate sensor output signals by physical means, e.g., a wiring configuration such as a terminal, a connector, or a harness.

### Fourth Embodiment

The following describes the fourth embodiment of the present disclosure. The fourth embodiment also differs from the first embodiment in a method of transmitting sensor output signals from the four sensors 11 to 14 to the two ECUs 21 and 22, and other aspects are the same as in the first embodiment, thereby only the parts different from the first embodiment and the like will be described.

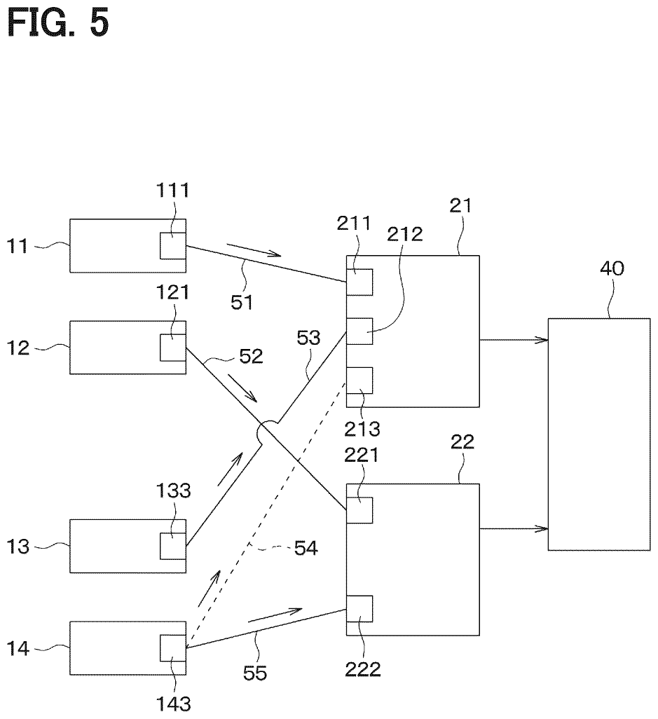

In the fourth embodiment, a method of transmitting sensor output signals from four sensors 11 to 14 to two ECUs 21 and 22 will be explained with reference to FIG. 5.

A first sensor 11 transmits a sensor output signal generated in its own sensor from a transmitter 111 of the first sensor 11 to a first receiver 211 of the first ECU 21 via a first wiring 51.

The second sensor 12 transmits a sensor output signal generated in its own sensor from a transmitter 121 of the second sensor 12 to a first receiver 221 of the second ECU 22 via a second wiring 52.

A third sensor 13 transmits a sensor output signal generated in its own sensor from a transmitter 133 of the third sensor 13 to a second receiver 212 of the first ECU 21 via a third wiring 53.

A fourth sensor 14 processes one sensor output signal generated in its own sensor to make and distribute two output signals using a wiring configuration provided in a transmitter 143 or the like. The two sensor signals duplicated by the wiring configuration are the same signal. Then, the fourth sensor 14 transmits one of the two sensor output signals from the transmitter 143 of the fourth sensor 14 to a third receiver 213 of the first ECU 21 via a fourth wiring 54. Further, the fourth sensor 14 transmits the other of the two sensor output signals from the transmitter 143 of the fourth sensor 14 to a second receiver 222 of the second ECU 22 via a fifth wiring 55. Therefore, the fourth sensor 14 processes one sensor output signal generated in its own sensor to make two sensor output signals by the wiring configuration, and transmits the two sensor output signals to the first ECU 21 and the second ECU 22, respectively.

As a communication method between each of the sensors 11 to 14 and each of the ECUs 21, 22, analog communication, digital communication, optical communication, and the like are adoptable. Examples of digital communications include SPI, I2C, UART, SENT, and the like.

Note that when SENT is adopted as the communication method, a transmitter unit is a driver and a receiver unit is a receiver. In the fourth embodiment, the first wiring 51, the second wiring 52, the third wiring 53, and the fifth wiring 55 are wirings having the supply voltage line, the signal line, and the ground line. On the other hand, the fourth wiring 54 is a wiring that has the signal line and the ground line, but does not have the supply voltage line. Therefore, the fourth sensor 14 operates by receiving supply of electric power from the second ECU 22. Therefore, the fourth sensor 14 can continue to operate even when the first ECU 21 fails.

On the other hand, when analog communication is adopted as the communication method, the transmitter unit and the receiver unit are terminals, wiring, or connectors.

As explained above, the brake system of the fourth embodiment can also provide the same effects as the second embodiment. Further, in the fourth embodiment, the fourth sensor 14 can duplicate the sensor output signal by physical means such as a wiring configuration such as a terminal, a connector, or a harness.

### Other Embodiments

(1) In each of the above embodiments, the organ-type brake pedal device 30 has been described as an example of the brake pedal device 30. However, the brake pedal device 30 is not limited thereto, and the brake pedal device 30 may also be, for example, a pendant-type brake pedal device. A pendant-type brake pedal device is one in which a portion of the brake pedal 31 that is stepped on by the driver is disposed below the swing axis CL in the vertical direction when mounted on a vehicle.
(2) In each of the above embodiments, the brake system has been described as including two ECUs 21 and 22. However, the brake system is not limited thereto, and may also include three ECUs. In other words, the brake system only needs to include at least two ECUs 21 and 22.

The present disclosure is not limited to the above-described embodiments, and can be appropriately modified. The above-described embodiments are not independent of each other, and can be appropriately combined together except when the combination is obviously impossible. Further, individual elements or features of a particular embodiment are not necessarily essential unless it is specifically stated that the elements or the features are essential in the foregoing description, or unless the elements or the features are obviously essential in principle. Further, in each of the embodiments described above, when numerical values such as the number, numerical value, quantity, range, and the like of the constituent elements of the embodiment are referred to, except for a case where the numerical values are expressly indispensable in particular, a case where the numerical values are obviously limited to a specific number in principle, and the like, the present disclosure is not limited to such specific number. A shape, positional relationship or the like of a structural element, which is referred to in the embodiments described above, is not limited to the described shape, positional relationship or the like, unless it is specifically described or obviously necessary to be limited in principle.

The control unit and the method thereof described in the present disclosure may be implemented by a dedicated computer, which is configured by a processor and a memory programmed to execute one or multiple functions embodied by a computer program. Alternatively, the control unit and the method thereof described in the present disclosure may be implemented by a dedicated computer, which is configured by a processor and one or more dedicated hardware logic circuits. Alternatively, the control unit and the method thereof described in the present disclosure may be implemented by a combination of (i) a special purpose computer including (a) a processor programmed to perform one or more functions by executing a computer program and (b) a memory and (ii) a special purpose computer including a processor with one or more dedicated hardware logic circuits. The computer programs may be stored, as instructions to be executed by a computer, in a tangible, non-transitory computer-readable storage medium.

What is claimed is:

1. A brake system configured to drive and control a brake circuit that brakes a vehicle, the brake system comprising:
four sensors configured to generate and output sensor output signals according to an amount of operation of a brake pedal operated by a driver; and
at least two electronic control units configured to control a driving of the brake circuit based on a sensor output signal output from the sensor, wherein
the four sensors are a first sensor, a second sensor, a third sensor, and a fourth sensor,
the first sensor is configured to transmit a sensor output signal generated therein to a predetermined electronic control unit among the at least two electronic control units,
the second sensor is configured to transmit a sensor output signal generated therein to an other electronic control unit that is different from the predetermined electronic control unit among the at least two electronic control units,
the third sensor is configured to transmit a sensor output signal generated therein to at least one of the predetermined electronic control unit or the other electronic control unit, and
the fourth sensor is configured to transmit a sensor output signal generated therein to both of the predetermined electronic control unit and the other electronic control unit.

2. The brake system of claim 1, wherein
the third sensor is configured to process one sensor output signal generated therein, to generate and distribute two sensor output signals in an integrated circuit of the sensor, and to transmit the two sensor output signals respectively to the predetermined electronic control unit and the other electronic control unit, and
the fourth sensor is configured to process one sensor output signal generated therein, to generate and distribute two sensor output signals in an integrated circuit of the sensor, and to transmit the two sensor output signals respectively to the predetermined electronic control unit and the other electronic control unit.

3. The brake system of claim 1, wherein
the third sensor is configured to transmit a sensor output signal generated therein only to one of the predetermined electronic control unit or the other electronic control unit, and
the fourth sensor is configured to process one sensor output signal generated therein, to generate and distribute two sensor output signals in an integrated circuit of the fourth sensor, and to transmit the two sensor output signals respectively to the predetermined electronic control unit and the other electronic control unit.

4. The brake system of claim 1, wherein
the third sensor is configured to process a sensor output signal generated therein, to make and distribute two output signals by a wiring configuration, and to transmit the sensor output signals to the predetermined electronic control unit and the other electronic control unit, respectively, and
the fourth sensor is configured to process a sensor output signal generated therein, to make and distribute two output signals by a wiring configuration, and to transmit the sensor output signals to the predetermined electronic control unit and the other electronic control unit, respectively.

5. The brake system of claim 1, wherein
the third sensor is configured to transmit a sensor output signal generated therein only to one of the predetermined electronic control unit or the other electronic control unit, and
the fourth sensor is configured to process a sensor output signal generated therein, to make and distribute two output signals by a wiring configuration, and to transmit the sensor output signals to the predetermined electronic control unit and the other electronic control unit, respectively.

6. The brake system of claim 1, wherein
one of analog communication, digital communication, and optical communication is adopted as a communication between the sensor and the electronic control unit.

7. The brake system of claim 1, wherein
at least one of the four sensors is a magnetic sensor and the other sensors are inductive sensors.

8. A brake pedal device for a brake system that includes at least two electronic control units configured to drive and control a brake circuit for braking a vehicle, the brake pedal device comprising:
a brake pedal to be operated by a driver; and
four sensors configured to generate and output sensor output signals according to an amount of operation of the brake pedal, wherein
the four sensors are a first sensor, a second sensor, a third sensor, and a fourth sensor,
the first sensor is configured to transmit a sensor output signal generated therein to a predetermined electronic control unit among the at least two electronic control units,
the second sensor is configured to transmit a sensor output signal generated therein to an other electronic control unit that is different from the predetermined electronic control unit among the at least two electronic control units,
the third sensor is configured to transmit a sensor output signal generated therein to at least one of the predetermined electronic control unit or the other electronic control unit, and
the fourth sensor is configured to transmit a sensor output signal generated therein to both of the predetermined electronic control unit and the other electronic control unit.
